(19) United States
(12) Patent Application Publication
(10) Pub. No.: US 2015/0373955 A1
(43) Pub. Date: Dec. 31, 2015

(54) Aquarium Filter

(71) Applicant: Steven Yim, La Habra, CA (US)

(72) Inventor: Steven Yim, La Habra, CA (US)

(21) Appl. No.: 14/850,201

(22) Filed: Sep. 10, 2015

Related U.S. Application Data
(63) Continuation-in-part of application No. 13/768,896, filed on Feb. 15, 2013.

(51) Int. Cl. A01K 63/04

(52) U.S. Cl. CPC A01K 63/045

(57) ABSTRACT

A media reactor aquarium filter incorporates a simple design and allows simple media replacement. The filter includes co-axial inner and outer tubes. The outer tube includes a mounting feature and the inner tube holds the media and is removable without disturbing the outer tube. A pump at the base of the filter pumps water into the inner tube through ports at the base of the inner tube and up through the inner tube, and thus through the media. The filtered water then flows through the top wall of the inner tube and down between the inner and outer tubes, and back into the aquarium. The inner tube is rotatable to vary the alignment of the ports to adjust the water flow rate through the filter.

### CROSS-REFERENCE TO RELATED APPLICATIONS

The present application is a Continuation In Part of U.S. patent application Ser. No. 13/768,896 filed Feb. 15, 2013, which application is incorporated in its entirety herein by reference.

### BACKGROUND OF THE INVENTION

The present invention relates to filters and in particular to aquarium filters.

Aquarium filters are utilized to maintain water purity in aquariums. While a variety of filters are available, they generally include flexible tubing, PVC pipe, ball valves, thumb screws, and various features creating unattractive clutter and complexity. Changing media in media filters is often messy and time consuming.

### BRIEF SUMMARY OF THE INVENTION

The present invention addresses the above and other needs by providing a media reactor aquarium filter which incorporates a simple design and allows simple media replacement. The filter includes coaxal inner and outer tubes. The outer tube includes a mounting feature and the inner tube holds the media and is removable without disturbing the outer tube. A pump at the base of the filter pumps aquarium water into the bottom of the inner tube through ports at the base of the inner tube and up through the inner tube, and thus through the filter media. The filtered water then flows though transfer ports at the top of the inner tube and down through a passage between the inner and outer tubes, and back into the aquarium. The flow is thus a sequential forward flow through the pump to the inlet ports, through the inlet ports and into the inner tube interior, up through the inner tube and filter media to the transfer ports, out through the transfer ports to the passage, down through the passage to the bottom of the filter, and out through the outlet ports into the aquarium. This flow is substantially all of the flow through the filter, notwithstanding the possibility of minor leaks and the like. The inner tube is rotatable to vary the alignment of the ports to adjust the water flow rate through the filter.

In accordance with one aspect of the invention, there is provided an aquarium filter allowing simple replacement of filter media. Filter media is contained in an inner tube which is removable from an outer tube of the filter, with the outer tube remaining in the aquarium. The media is replaced in the inner tube, and the inner tube is inserted back into the outer tube.

In accordance with another aspect of the invention, there is provided an aquarium filter allowing simple adjustment of a water flow through the filter. Filter media is contained in an inner tube. Aquarium water is pumped by a pump into the base of the inner tube, vertically up through the media material in the inner tube, out of the inner tube into a region between the inner tube and an outer tube, back to the base of the filter, and released back into the aquarium. Ports in the base of the inner filter are adjustably alignable with ports leading to the pump. A knob at the top of the inner tube allows twisting the inner tube to adjust the alignment of the ports to control the water flow.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a cut away side view of an aquarium filter according to the present invention.

FIG. 1A is a cross-sectional view of the aquarium filter according to the present invention taken along line 1A-1A of FIG. 1.

FIG. 2 is an outer tube assembly of the aquarium filter according to the present invention.

FIG. 3 is an exploded view of an inner tube assembly of the aquarium filter according to the present invention.

FIG. 4 is an exploded view of the aquarium filter according to the present invention.

FIG. 5 is an inner tube top plug of the aquarium filter according to the present invention.

FIG. 6A is a side view of an inner tube base plug of the aquarium filter according to the present invention.

FIG. 6B is a side-top perspective view of the inner tube base plug of the aquarium filter according to the present invention.

FIG. 7 is an outer tube base plug of the aquarium filter according to the present invention.

FIG. 8A is a mounting clamp of the aquarium filter according to the present invention.

FIG. 8B is a mounting platform of the aquarium filter according to the present invention.

FIG. 9 shows the aquarium filter according to the present invention mounted inside an aquarium.

FIG. 10 shows the aquarium filter according to the present invention mounted behind the aquarium.

FIG. 11 shows the aquarium filter according to the present invention mounted in a sump under the aquarium.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the term “generally” is associated with an element of the invention, it is intended to describe a feature's appearance to the human eye, and not a precise measurement. Further, in the context of the present application, a cylinder and cylindrical refer to a shape having a constant round cross-section over the length of the shape. Further, the phrase forward fluid flow or forward communication refers to a flow in the normal direction of flow of aquarium water through the aquarium filter, and aquarium water refers to the water in the aquarium and outside the filter. For example, a forward fluid flow is present from the filter pump to the filter media, and from the filter media to the outlet.

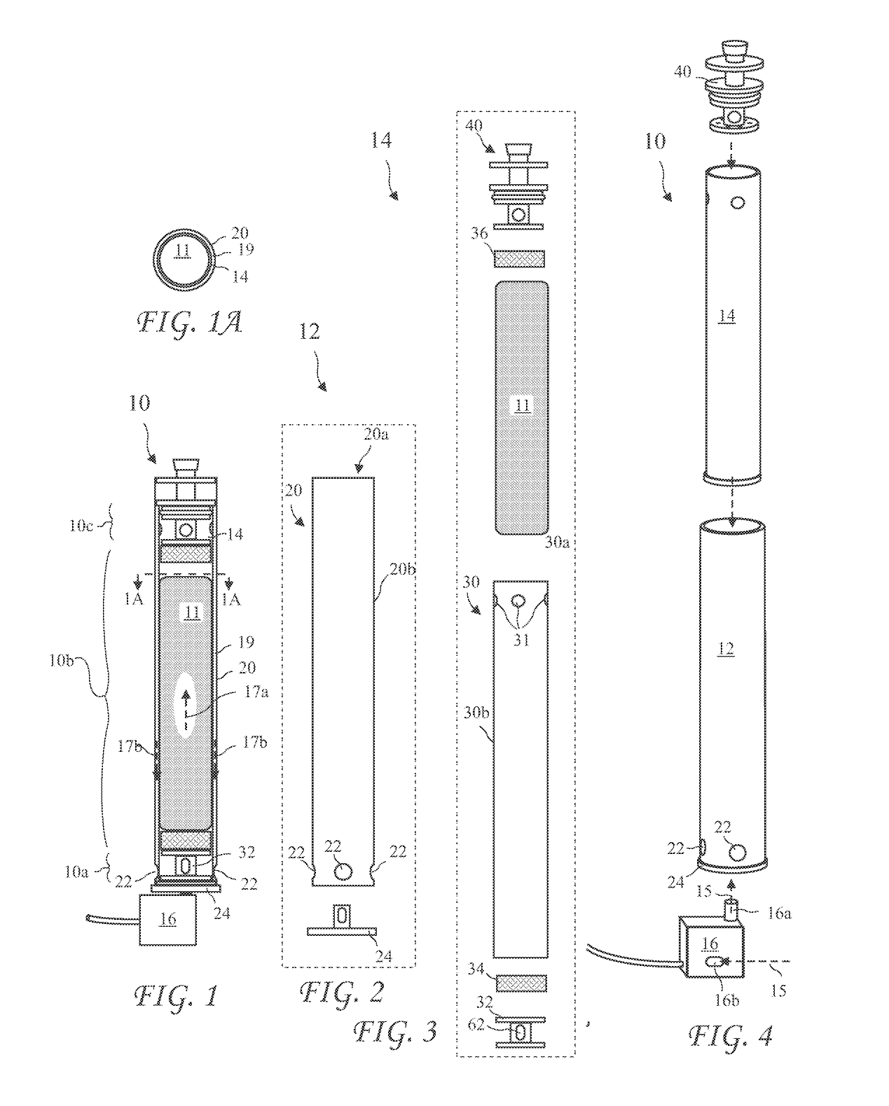

A cutaway side view of an aquarium filter 10 according to the present invention is shown in FIG. 1 and a cross-sectional view of the aquarium filter according to the present invention taken along line 1A-1A of FIG. 1 is shown in FIG. 1A. A cylindrical inner tube 30 having an inner tube interior 30a and an inner tube exterior 30b (see FIG. 3) resides inside a cylindrical outer tube 20 having an outer tube interior 20a and an outer tube exterior 20b, both the inner tube 30 and outer tube 20 preferably having round cross-sections. Filter media 11 resides inside the inner tube 30 and the outer tube exterior 20b is exposed to aquarium water in the aquarium. The aquarium filter 10 includes an inlet/outlet portion 10a at the bottom of the aquarium filter 10, a transfer portion at the top of the aquarium filter 10, and a filter portion 10b containing the filter media 11 between the inlet/outlet portion 10a and the transfer portion 10c. The portions 10a, 10b, and 10c are preferably sequential and non-overlapping.

A filter pump 16 draws aquarium water 15 into the aquarium filter 10 providing a forward aquarium filter flow 17a (unfiltered) and 17b (filtered) through an inlet/outlet portion 10a and up and inside the inner tube 30, and through the filter media 11, to filter aquarium water creating filtered water 17. The filtered water 17 passes radially outward through transfer ports 31 at the top of the inner tube 30 into an annular passage 19 between the inner tube 30 and the outer tube 20, and out exit ports 22 in the outer tube 20, and into the aquarium 80 (see FIGS. 9-11). The outer tube 20 provides a closed circumferential wall above the exit ports 22 at the base of the outer tube 20 to the transfer portion 10c preventing entry or escape of aquarium water into or out of the passage 19 above the inlet/outlet portion 10a. The inner tube 30 similarly provides a closed circumferential wall between inlet/outlet portion 10a at the bottom of the inner tube 30 and the transfer portion 10c at the top of the inner tube 30.

An exploded view of an outer tube assembly 12 of the aquarium filter 10 is shown in FIG. 2. The outer tube assembly 12 comprises an outer tube 20, an outer tube base plug 24 (see FIG. 7), and filter exit ports 22 spaced apart around the base of the outer tube 20. The outer tube 20 may be any elongated tube, and is preferably a cylindrically shaped tube.

FIG. 3 is an exploded view of an inner tube assembly 14 of the aquarium filter 10. The inner tube assembly 14 includes an inner tube 30, an inner tube base plug 32 fixed to the base of the inner tube 30, a lower water permeable spacer 34 resting on the base plug 32, filter media 11, an upper water permeable spacer 36 resting on the filter media 11, and an inner tube top plug 40

FIG. 4 is an exploded view of the aquarium filter 10. The filter pump 16 includes a pump spindle 16a inserted into a hollow interior 71a of an outer tube base plug spindle 71 to place the aquarium filter 10 in fluid communication with the pump 16. The filter pump 16 includes an aquarium water inlet 16b drawing aquarium water 15 proximal to the aquarium filter bottom from outside the aquarium filter 10.

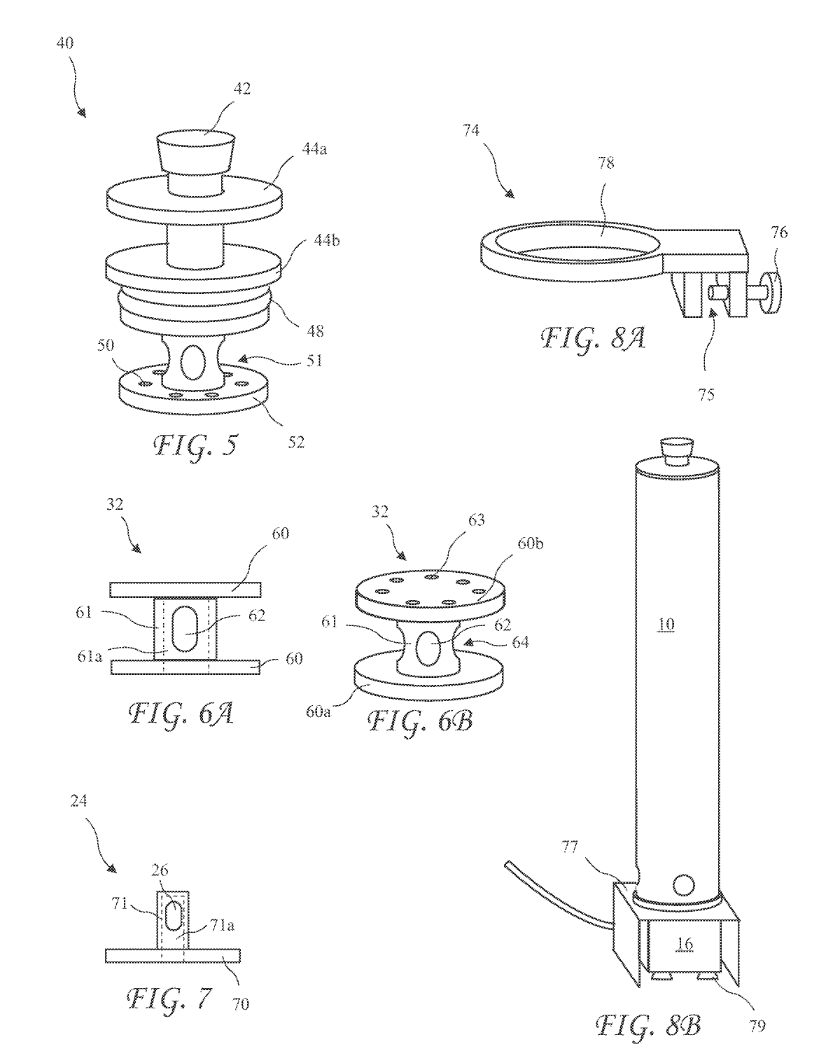

A detailed view of the inner tube top plug 40 is shown in FIG. 5. The top plug 40 includes a knob 42 for rotating the inner tube assembly 14 inside the outer tube assembly 12, first and second outer tube positioners 44a and 44b, an inner tube seal 48, and an inner tube positioner 52. The positioners 44a, 44b, and 52 center the inner tube inside the outer tube and the seal 48 restricts filtered water from escaping out of the top of the aquarium filter. Vertical ports 50 on the positioner 52 allow filtered water to pass through the positioner 52 into a transfer region 51 and through the transfer ports 31 (see FIG. 3) into the outer tube 20. The transfer region 51 resides in the transfer portion 10c of the aquarium filter 10.

FIG. 6A shows a detailed side view of the inner tube base plug 32 of the aquarium filter 10 and FIG. 6B shows a top-side perspective view of the inner tube base plug 32. The base plug 32 includes inner tube base plug positioners 60a and 60b which center the base plug 32 in the inner tube 30. Inner tube inlet ports 62 pass into an interior 61a of a hollow hub 61 between the positioners 60a and 60b. Entry ports 63 in the upper positioner 60b allow water in an entry region 64 to pass vertically into the filter portion 10b of the aquarium filter 10. The base plug 32 resides in the inlet/outlet portion 10a of the aquarium filter 19 below the filter 11 fixed to the inner tube 30 and rotates with the inner tube 30.

FIG. 7 shows a detailed view of the outer tube base plug 24 of the aquarium filter 10. The base plug 24 is fixed in the base of the outer tube 20 by an outer tube base plug positioner 70 which includes a spindle 71 reaching up into the outer tube 20 and the inner tube 30. The spindle 71 is hollow with an open bottom for connected through the filter pump spindle 16a to the filter pump 16 and includes outer tube inlet ports 26 between the spindle interior 71a and exterior. The inner tube base plug 32 resides over the spindle 71 and the inner tube inlet ports 62 are alignable with the inlet ports 62 allowing aquarium water pumped by the aquarium pump 16 to enter the inner tube 30. Rotating the inner tube 30, and thus the base plug 32, varies the alignment of the inlet ports 26 with the inlet ports 62 thus regulating the water flow from the filter pump 16 into the inner tube 30. The inlet ports 26 and 62 preferably have a height greater than width, and are more preferably oval shaped.

FIG. 8A shows a mounting clamp 74 of the aquarium filter 10. The mounting clamp 74 includes a loop 78 which fits over the outer tube 20, and may be an interference fit or attached using an adhesive. The mounting clamp 74 may include a slot 75 for sliding onto an edge of the aquarium and a screw 76 for tightening.

FIG. 8B shows a mounting platform 77 for the aquarium filter 10. In some instances a user may choose to locate the filter 10 away from the aquarium walls. In such instances the mounting platform 77 may be positioned within the aquarium fixed to the aquarium bottom using attachments, for example, suction cups 79 attached to the pump 16 or to the platform 77. The filter 10 is attached to the mounting platform 77 to prevent the filter 10 from rotating when the inner tube 30 is rotated to adjust the water flow.

FIG. 9 shows the aquarium filter 10 mounted inside an aquarium 18. The top of the filter 10 is above a water line 82 to allow reaching the knob 42.

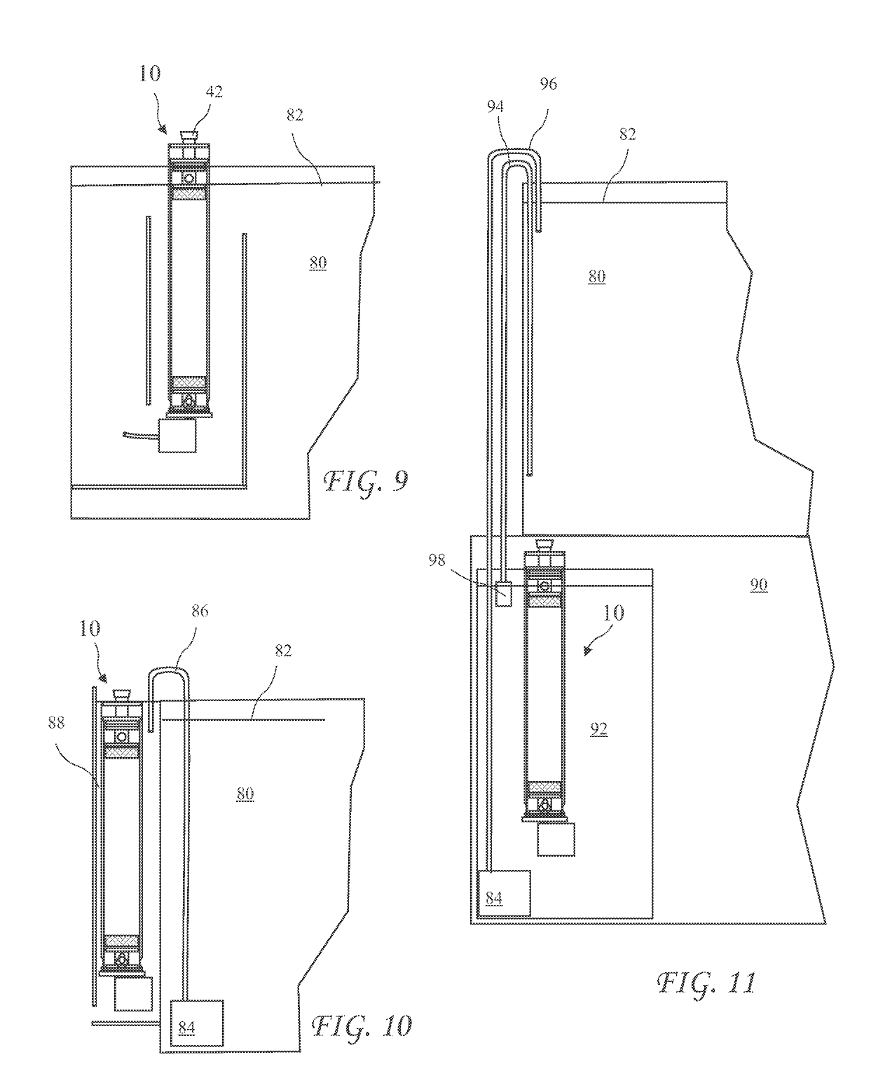

FIG. 10 shows the aquarium filter 10 mounted behind the aquarium 80 in a basin 88. An aquarium pump 84 may be used to circulate aquarium water into the basin 88.

FIG. 11 shows the aquarium filter 10 mounted in a sump 92 residing in an aquarium stand 90 under the aquarium 80. Aquarium water may be released into the sump 92 through a drain tube 94 and valve 98, and pumped back into the aquarium 80 by the aquarium pump 84 through tube 96.

While the filter has been shown as including coaxal inner and outer elongated bodies comprising cylindrical tubes, a filter having square, rectangular, hexagonal, oval, or other cross-section, and filter media residing in a removable inner body and a water flow through the inner body, between the bodies, and back into an aquarium, is intended to come within the scope of the present invention.

While the invention herein disclosed has been described by means of specific embodiments and applications thereof, numerous modifications and variations could be made thereto by those skilled in the art without departing from the scope of the invention set forth in the claims.

I CLAIM:

1. An aquarium filter comprising:
an aquarium filter bottom;
an aquarium filter top opposite to the aquarium filter bottom;
an elongated outer tube having:
an outer tube bottom end proximal to the aquarium filter bottom;
an outer tube top end proximal to the aquarium filter top and opposite to the outer tube bottom end;
an outer tube interior; and
an outer tube exterior;
an elongated inner tube residing inside the outer tube and having:
an inner tube bottom end adjacent to the outer tube bottom end;
an inner tube top end opposite to the inner tube bottom end and adjacent to the outer tube top end;
an inner tube exterior; and
an inner tube interior;
a filter pump residing proximal to the aquarium filter bottom, the filter pump including an aquarium water inlet placing aquarium water, outside the aquarium filter and proximal to the aquarium filter bottom, in fluid communication with the filter pump;
an inlet path residing at the bottom of the aquarium filter placing the filter pump in fluid communication with the inner tube interior at the inner tube bottom end;
transfer ports, between the inner tube interior at the inner tube top end and the outer tube interior at the outer tube top end, placing the inner tube interior in fluid communication with the outer tube interior;
filter media residing in the inner tube interior between the inlet ports and the transfer ports;
a continuous passage between the outer tube interior and the inner tube exterior, the passage reaching from the transfer ports to the outer tube bottom end and placing the transfer ports in fluid communication the outer tube interior at the outer tube bottom end;
outlet ports at the bottom of the aquarium filter in fluid communication with the passage placing the passage in fluid communication with the aquarium, and
a forward aquarium filter flow sequentially through the pump to the inlet ports, through the inlet ports and into the inner tube interior, up through the inner tube and filter media to the transfer ports, out through the transfer ports to the passage, down through the passage to the bottom of the filter, and out through the outlet ports into the aquarium.

2. The filter of claim 1, wherein the passage is an annular passage between the inner tube and the outer tube.

3. The filter of claim 1, wherein the inner tube and the outer tube are coaxial cylinders.

4. The filter of claim 3, wherein the inner tube and the outer tube have round cross-sections.

5. The filter of claim 1, wherein the inlet path comprises:
a filter pump spindle reaching up from the filter pump into the aquarium filter;
an outer tube base plug fixed to the outer tube bottom and configured to receive the filter pump spindle, the outer tube base plug including an outer tube base plug spindle having a hollow interior and reaching upward into the aquarium filter;
outer tube inlet ports in walls of the outer tube base plug spindle, the outer tube inlet ports in fluid communication with the filter pump through the hollow interior of the outer tube base plug and the filter pump spindle; and
an inner tube base plug fixed to the inner tube bottom end inside the inner tube interior, the inner tube base plug including inner tube inlet ports,
wherein the filter pump is in fluid communication with the inner tube interior sequentially and exclusively through the filter pump spindle, the outer tube base plug spindle, the outer tube inlet ports, and the inner tube inlet ports.

6. The filter of claim 5, wherein the inner tube base plug is rotatable with the inner tube to provide a range of alignments between the outer plug inlet ports and the inner tube inlet ports.

7. The filter of claim 6, wherein the inner tube and the outer tube are cylindrically shaped.

8. The filter of claim 6, wherein the outer tube is attachable to the aquarium by a clamp attached around the outer tube.

9. The filter of claim 6, wherein the outer tube is attachable to the aquarium by a mounting platform fixable to an aquarium floor and holding the outer tube to allow removal of the inner tube from the outer tube to replace filter media and rotation of the inner tube within the outer tube.

10. The filter of claim 6, wherein the outer tube exterior is in direct contact with the aquarium water.

11. An aquarium filter comprising:
an aquarium filter bottom;
an aquarium filter top opposite to the aquarium filter bottom;
an inlet/outlet portion proximal to the aquarium filter bottom;
a transfer portion proximal the aquarium filter top;
a filter portion between the inlet/outlet portion and the transfer portion;
an outer tube having an outer tube interior and an outer tube exterior;
a rotatable inner tube residing inside the outer tube and having an inner tube exterior and an inner tube interior;
a filter pump residing under the inlet/outlet portion, the filter pump including an aquarium water inlet placing aquarium water, outside the aquarium filter and proximal to the aquarium filter bottom, in fluid communication with the filter pump;
a filter pump spindle reaching up from the filter pump into the aquarium filter;
an outer tube base plug fixed to the outer tube bottom and configured to receive the filter pump spindle, the outer tube base plug including an outer tube base plug spindle having a hollow interior and reaching upward into the aquarium filter;
outer tube inlet ports in walls of the outer tube base plug spindle, the outer tube inlet ports in fluid communication with the filter pump through the hollow interior of the outer tube base plug and the filter pump spindle; and
an inner tube base plug fixed to the inner tube bottom end inside the inner tube interior, the inner tube base plug including inner tube inlet ports, the inner tube inlet ports alignable with the outer tube inlet ports;
wherein the filter pump is in fluid communication with the inner tube interior, for pumping the aquarium water through the aquarium filter, sequentially and exclusively through the filter pump spindle, the outer tube base plug spindle, the outer tube inlet ports, and the inner tube inlet ports.
transfer ports, between the inner tube interior at the inner tube top end and the outer tube interior and residing in the transfer portion, placing the inner tube interior in fluid communication with the outer tube interior;
filter media residing in the inner tube interior in the filtering portion;
a continuous passage between the outer tube interior and the inner tube exterior, the passage reaching from the transfer portion to the inlet/outlet portion and placing the transfer ports in fluid communication the outer tube interior at the inlet/outlet portion;
outlet ports in the inlet/outlet portion in fluid communication with the passage placing the passage in fluid communication with the aquarium.

12. The filter of claim 11, further including a forward aquarium filter flow exclusively sequentially through the pump to the inlet/outlet portion, through the inlet/outlet portion and into the filter portion, up through the filter portion and the filter media to the transfer portion, through the transfer portion to the filter portion and the passage, down through the passage in the filter portion to the inlet/outlet portion, and out through the inlet/outlet portion into the aquarium.

13. The filter of claim 11, wherein the inlet/outlet portion, the filter portion, and the transfer portion are non-overlapping.

14. An aquarium filter comprising:
a cylindrical outer tube attachable to an aquarium and having an outer tube interior, an outer tube exterior, an outer tube bottom end and outer tube top end opposite to the outer tube bottom end;
an outer tube base plug fixed to the outer tube bottom end and including outer tube inlet ports;
a cylindrical inner tube residing coaxial and inside the outer tube and having an inner tube interior, an inner tube exterior, an inner tube bottom end and an inner tube top end opposite to the inner tube bottom end, the inner tube rotatable inside the outer tube and removable from the outer tube;
filter media residing inside the inner tube and replaceable by removing the inner tube from the outer tube;
an inner tube base plug fixed inside at the inner tube bottom end having inner tube inlet ports, an alignment of the inner tube inlet ports with the outer tube inlet ports is adjustable by rotating the inner tube to control the flow rate of aquarium water through the aquarium filter, an entire forward flow of aquarium water into the filter through the outer tube inlet ports and the inner tube inlet ports;
a pump residing at a bottom end of the filter in forward fluid communication between the aquarium and the inner tube bottom end through the outer tube inlet ports and the inner tube inlet ports;
transfer ports in the inner tube top end placing the inner tube interior at the inner tube top end in fluid communication with outer tube interior, the inlet ports in forward fluid communication with the transfer ports solely through the filter media;
an annular passage between the inner tube and the outer tube and adjacent to the filter media in the inner tube; and
outlet ports at an outer tube bottom end providing forward fluid communication between the annular passage and the aquarium and allowing filtered water to be released into the aquarium and the entire forward flow out of the aquarium filter through the outlet ports in the outer tube bottom end.
